(19) United States
(12) Patent Application Publication
(10) Pub. No.: US 2026/0369799 A1
(43) Pub. Date: Nov. 19, 2026

(54) SECONDARY BATTERY AND METHOD FOR MANUFACTURING SECONDARY BATTERY

(71) Applicant: Samsung SDI Co., Ltd., Yongin-si (KR)

(72) Inventor: Ho Seong KIM, Yongin-si (KR)

(21) Appl. No.: 19/569,936

(22) Filed: Mar. 17, 2026

(30) Foreign Application Priority Data
May 14, 2025 (KR) 10-2025-0062544

(51) Int. Cl. H01M 50/375; B60L 50/64; H01M 10/04; H01M 50/105; H01M 50/342; H01M 50/474; H01M 50/477

(52) U.S. Cl. CPC H01M 50/375; H01M 10/049; H01M 50/105; H01M 50/3425; H01M 50/474; H01M 50/477; B60L 50/64; H01M 2220/20; H01M 2220/30

(57) ABSTRACT

A secondary battery includes an electrode assembly and a case configured to accommodate the electrode assembly and sealed by thermally compressing a lower plate and an upper plate in a circumferential direction. The upper plate includes at least two upper plates, and a thermoplastic adhesive layer is interposed between the at least two upper plates. The thermoplastic adhesive layer is maintained in adhesion at a normal operation temperature, but if an internal temperature of the secondary battery exceeds a set critical temperature, the thermoplastic adhesive layer is melted to provide a vent passage between the at least two upper plates.

### CROSS-REFERENCE TO THE RELATED APPLICATION

The present application claims priority to and the benefit of Korean Patent Application No. 10-2025-0062544, filed on May 14, 2025, in the Korean Intellectual Property Office, the entire disclosure of which is incorporated herein by reference.

### BACKGROUND

### 1. Field

One or more embodiments of the present disclosure relate to a secondary battery and a method for manufacturing the secondary battery.

### 2. Description of the Related Art

Unlike primary batteries, secondary batteries are designed to be repeatedly charged and discharged. Low-capacity secondary batteries, which may include a single battery cell packaged in a pack, have been widely used in small, portable electronic devices such as smartphones, feature phones, laptop computers, digital cameras, and/or camcorders. In contrast, large-capacity secondary batteries have been widely employed as power sources for driving motors in hybrid vehicles, electric vehicles, and the like, as well as for power storage applications.

A secondary battery generally includes an electrode assembly including (e.g., consisting of) a positive electrode and a negative electrode, a case that houses (accommodates) the electrode assembly, and electrode terminals connected to the electrode assembly.

The above information disclosed in this Background section is for enhancement of understanding of the background of the disclosure and therefore it may contain information that does not constitute prior art.

### SUMMARY

One or more aspects of embodiments of the present disclosure are directed toward a structure of an exterior that automatically provides a ventilation passage if (e.g., when) an internal temperature rises through an exterior lamination design and applying of a thermoplastic adhesive layer to quickly and stably discharge a gas and maintains a completely sealed state during normal times.

Additional aspects will be set forth in part in the description which follows and, in part, will be apparent from the description, or may be learned by practice of the presented embodiments. However, the technical problems to be achieved in embodiments of the disclosure are not limited to the technical problems mentioned above, and other technical problems not mentioned herein will be clearly understood from the following description by those skilled in the art to which the disclosure belongs.

According to one or more embodiments of the present disclosure, a secondary battery includes: an electrode assembly; and a case configured to accommodate the electrode assembly and sealed by thermally compressing a lower plate and an upper plate in a circumferential direction, wherein the case (e.g., the upper plate) includes at least two upper plates, and a thermoplastic adhesive layer is interposed between the at least two upper plates, wherein the thermoplastic adhesive layer is maintained in adhesion at a normal operation temperature, but if (e.g., when) an internal temperature of the secondary battery exceeds a set critical temperature, the thermoplastic adhesive layer is melted to provide a vent passage between the at least two upper plates.

According to one or more embodiments, the at least two upper plates may include: a first upper plate including an upper flat part corresponding to a shape of the electrode assembly and a side connection part bent at a set or predetermined angle from the upper flat part toward the lower plate to extend; and a second upper plate including a sealing part that is thermally fused with the lower plate and a sidewall bent at a set or predetermined angle from the sealing part toward the first upper plate to extend.

According to one or more embodiments, the second upper plate may be coupled to be fitted into the first upper plate.

According to one or more embodiments, the sidewall may be constituted by an inner surface sidewall at a side of the electrode assembly, an outer surface sidewall at a side of the side connection part of the first upper plate, and a top surface sidewall between the inner surface sidewall and the outer surface sidewall.

According to one or more embodiments, the thermoplastic adhesive layer may be applied to (e.g., on) the outer surface sidewall and the top surface sidewall of the second upper plate.

According to one or more embodiments, the sealing part may be arranged only on (e.g., in)) a circumferential area in (e.g., on) which the electrode assembly is not arranged.

According to one or more embodiments, the at least two upper plates may further include a third upper plate interposed between the first upper plate and the second upper plate and provided in a frame shape (e.g., in a shape of a frame).

According to one or more embodiments, the third upper plate may be coupled to be fitted into the first upper plate, and the second upper plate may be coupled to be fitted into the third upper plate.

According to one or more embodiments, the third upper plate may include an inner surface at a side of the second upper plate, an outer surface at a side of the first upper plate, and a top surface between the inner surface and the outer surface, and the thermoplastic adhesive layer may be applied to the second upper plate and the top surface and the outer surface of the third upper plate.

According to one or more embodiments, the thermoplastic adhesive layer may have a melting point in a range from about 110 degrees (°C) to about 132 degrees (°C).

According to one or more embodiments, the thermoplastic adhesive layer may be made of at least one of a polyolefin resin or a styrene resin.

According to one or more embodiments, the thermoplastic adhesive layer may include at least one of α-methylstyrene acrylonitrile copolymer (AMSAN), linear low density polyethylene (LLDPE), or high density polyethylene (HDPE).

According to one or more embodiments, the thermoplastic adhesive layer may be on (e.g., applied to) an outer surface of an inner upper plate of the at least two upper plates and may be on (e.g., applied to) an entire or at least a portion of the outer surface of the inner upper plate.

According to one or more embodiments, each upper plate of the at least two upper plates may have a multi-layer structure including an outer layer, a central layer, an inner layer, and an adhesive layer configured to couple the layers (e.g., the outer layer, the central layer, and the inner layer) to each other.

According to one or more embodiments, the outer layer may be made of a nylon-based film, the central layer may be made of a metal film, and the inner layer may be made of a polypropylene film or a polyolefin-based film.

According to one or more embodiments, the adhesive layer may include at least one resin of polyurethane, modified polyolefin, epoxy, acrylic, or polyester.

According to one or more embodiments of the present disclosure, a method for manufacturing a secondary battery includes: preparing a first upper plate including (e.g., provided with) an accommodation part, in which an electrode assembly is accommodated, and a second upper plate including (e.g., provided with) a sealing part that is configured to be thermally fused with a lower plate; interposing a thermoplastic adhesive layer between the first upper plate and the second upper plate to couple the first upper plate to the second upper plate; preparing the lower plate with a shape and size corresponding to those of the second upper plate so as to be thermally fused with the sealing part of the second upper plate; arranging the electrode assembly in the accommodation part of the first upper plate; and thermally fusing the lower plate and the sealing part of the second upper plate to seal the first upper plate and the second upper plate, wherein the thermoplastic adhesive layer is maintained in adhesiveness at a normal operation temperature, but if (e.g., when) an internal temperature exceeds a set critical temperature, the thermoplastic adhesive layer is melted to form a vent passage between the first upper plate and the second upper plate.

According to one or more embodiments, the thermoplastic adhesive layer may be applied in at least one method of a spraying method, a slot die method, or a dipping method.

According to one or more embodiments, the thermoplastic adhesive layer may be applied by being melted in a temperature range of about 110 degrees (°C) to about 132 degrees (°C).

According to one or more embodiments, the coupling of the first upper plate to the second upper plate may further include: preparing a third upper plate in a frame shape (e.g., in a shape of a frame) that is penetrated (e.g., extended) in a vertical direction; interposing the thermoplastic adhesive layer between the first upper plate and the third upper plate and between the third upper plate and the second upper plate; and coupling the third upper plate between the first upper plate and the second upper plate.

For example, the described configuration—including the interposition of a thermoplastic adhesive layer between at least two upper plates, and optionally a third upper plate in a frame shape—provides a secondary battery structure that is both thermally responsive and structurally stable. During normal operation, the adhesive layer maintains a sealed state to ensure containment and reliability. When the internal temperature exceeds a set or predetermined threshold, the adhesive layer melts within a defined temperature range (e.g., about 110 °C to about 132 °C), forming a vent passage between the upper plates to enable rapid gas discharge. This passive venting mechanism enhances safety without requiring additional mechanical components or active control systems. The manufacturing method described herein ensures precise alignment and thermal bonding of the plates, while integrating the adhesive layer in a manner that supports both sealing and venting functions. These structural and process contribute to the battery's safety, reliability, and manufacturability.

### BRIEF DESCRIPTION OF THE DRAWINGS

The accompanying drawings illustrate one or more example embodiments of the present disclosure, and serve to further facilitate understanding the technical idea of the present disclosure together with the detailed description of the present disclosure, and thus, the present disclosure should not be construed as being limited to the matters described in such drawings. The above and other aspects, features, and advantages of certain embodiments of the present disclosure will be more apparent from the following description taken in conjunction with the accompanying drawings, in which:

FIG. 1 illustrates a perspective view of a structure of a secondary battery according to one or more embodiments of the present disclosure;

FIG. 2 illustrates an exploded perspective view of the secondary battery of FIG. 1 according to one or more embodiments of the present disclosure;

FIG. 3 illustrates a perspective view of a first upper plate of a pouch of the secondary battery of FIG. 1 according to one or more embodiments of the present disclosure;

FIG. 4 illustrates a perspective view of a second upper plate of the pouch of the secondary battery of FIG. 1 according to one or more embodiments of the present disclosure;

FIG. 5 is a perspective view of a structure of a secondary battery according to one or more embodiments of the present disclosure;

FIG. 6 illustrates an exploded perspective view of the secondary battery of FIG. 5 according to one or more embodiments of the present disclosure;

FIG. 7 illustrates a perspective view of a third upper plate of a pouch of the secondary battery of FIG. 5 according to one or more embodiments of the present disclosure;

FIG. 8 is a cross-sectional view of a cut surface of each upper plate of the pouch according to one or more embodiments of the present disclosure;

FIG. 9 is a flowchart for explaining a method for manufacturing a secondary battery according to one or more embodiments of the present disclosure;

FIG. 10 is a view schematically showing a smartphone equipped with a secondary battery pack according to one or more embodiments of the present disclosure;

FIGS. 11 and 12 illustrate perspective views of an example of a battery pack according to one or more embodiments of the present disclosure; and

FIGS. 13 and 14 illustrate perspective and side views of examples of a vehicle body and vehicle components according to one or more embodiments of the present disclosure.

### DETAILED DESCRIPTION

Hereinafter, one or more embodiments of the present disclosure will be described, in more detail, with reference to the accompanying drawings. The terms or words used in the present disclosure and in the appended claims are not to be limitedly interpreted as general or dictionary meanings and should be interpreted as meanings and concepts that are consistent with the technical idea of the present disclosure on the basis of the principle that an inventor can be his/her own lexicographer to appropriately or suitably define concepts of terms to describe his/her invention in the best way. Therefore, the embodiments described in this disclosure and the configurations shown in the drawings are only some of the embodiments of the present disclosure and do not necessarily represent all of the technical spirit, aspects, and features of the present disclosure. Accordingly, it should be understood that there may be one or more suitable equivalents and modifications that may replace or modify the embodiments described herein at the time of filing this application. In addition, it will be understood that the terms “comprise(s)/comprising” and/or “include(s)/including” and/or “has(have)/having,” if (e.g., when) used in this disclosure, specify the presence of stated features, numbers, steps (e.g., acts or tasks), operations, elements, and/or components but do not preclude the presence or addition of one or more other features, numbers, steps (e.g., acts or tasks), operations, elements, components, and/or groups thereof. Additionally, the terms “comprise(s)/comprising,” “include(s)/including,” “has/have/having”, or other similar terms include or support the terms “consisting of” and “consisting essentially of,” indicating the presence of stated features, numbers, steps (e.g., acts or tasks), operations, elements, and/or components, without or essentially without the presence of other features, numbers, steps (e.g., acts or tasks), operations, elements, components, and/or groups thereof. In addition, if (e.g., when) describing embodiments of the present disclosure, the wording “may~” or “may be~” refers to “one or more embodiments of the present disclosure.”

In addition, for a better understanding of the disclosure, the attached drawings may not be drawn to scale and the dimensions of some components may be exaggerated or reduced for clarity. In addition, the same or like reference numbers may be assigned to the same or like components in different embodiments, and duplicative descriptions thereof may not be repeated for conciseness.

A reference to two objects in comparison being the same refers to that they are substantially the same. Thus, the wording “substantially the same” may include cases where the same is considered to be a low level in the related art, for example, a deviation within 5%. In addition, if (e.g., when) any of parameters is referred to as being uniform in a given region, it may refer to that the parameter is substantially uniform from an average perspective.

It will be understood that, although the terms “first,” “second,” and/or the like, may be used herein to describe one or more suitable components, these components should not be limited by these terms. These terms are used to distinguish one component from another component. Thus, unless otherwise defined, a first component described herein could be termed a second component, without departing from the spirit and scope of the present disclosure.

Throughout the disclosure, the singular forms are intended to include the plural forms as well, unless the context clearly indicates otherwise. For example, the singular forms “a,” “an,” “one,” and “the” are intended to include the plural forms as well, unless the context clearly indicates otherwise.

The arrangement of a component on the “upper portion (or lower portion)” or “upper (or lower)” of another component may refer to that the component is placed in contact with the upper (or lower) surface of the another component. In addition, it may also refer to that one or more other components may be interposed between the component and the another component arranged on (or under) the component.

Also, it will be understood that if (e.g., when) an element is referred to as being “coupled to,” “linked to,” or “connected to” another element, these elements may be directly coupled or connected to each other, or one or more intervening elements may be present therebetween, or the respective elements may be coupled, linked, or connected to each other through another elements. In addition, it will be understood that if (e.g., when) an element is referred to as being electrically coupled to another element, the element may be directly connected to the another element or one or more intervening elements may be present therebetween such that the element and the another element are indirectly connected to each other.

Throughout the disclosure, if (e.g., when) “A and/or B” or “A or B” or “A/B” is stated, it refers to A, B, or A and B, unless otherwise stated. For example, “and/or” or “or” or “/” may include any or all combinations of a plurality of items enumerated. If (e.g., when) “C to D” is stated, it refers to C or more and D or less, unless otherwise specified.

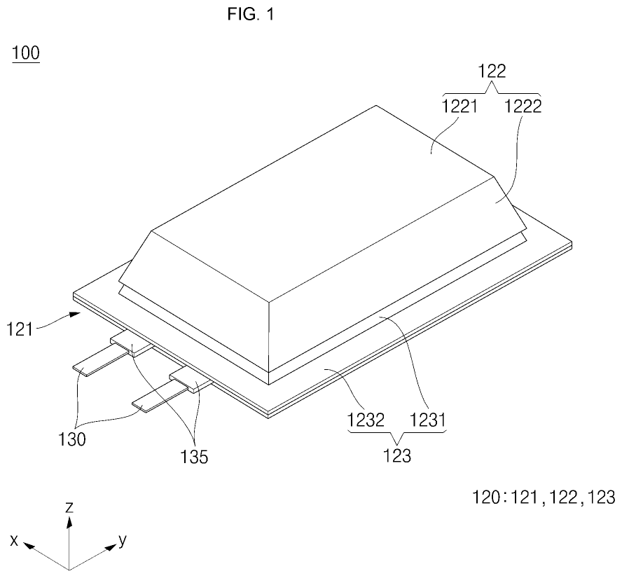

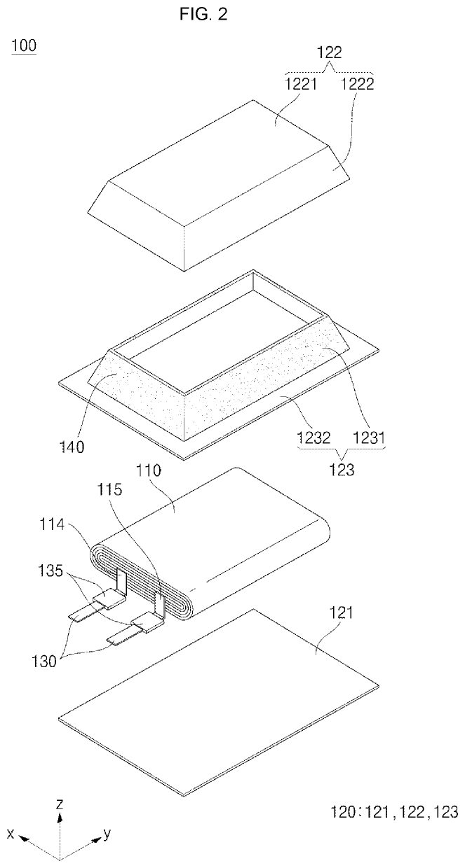

FIG. 1 illustrates a perspective view of a structure of a secondary battery 100 according to one or more embodiments of the present disclosure, and FIG. 2 illustrates an exploded perspective view of the secondary battery 100 of FIG. 1 according to one or more embodiments.

As shown in FIG. 1 and FIG. 2, the secondary battery 100 according to one or more embodiments of the present disclosure may include an electrode assembly 110 and a pouch 120 accommodating the electrode assembly 110.

The electrode assembly 110 includes a negative electrode plate as a first electrode plate, a positive electrode plate as a second electrode plate, and a separator interposed therebetween. In one or more embodiments, the electrode assembly 110 may be provided by laminating the negative electrode plate, the separator, and the positive electrode plate, each of which is provided in a thin plate shape (e.g., in a form of plate) or a film shape (e.g., in a form of film). In one or more embodiments, one or more electrode assemblies 110 may be stacked such that the electrode assemblies 110 are adjacent to each other and accommodated in the pouch 120, and the number of electrode assemblies 110 in the case (e.g., in the pouch 120) is not limited in the present disclosure. In one or more embodiments, the first electrode plate of the electrode assembly 110 may act as a negative electrode, and the second electrode plate may act as a positive electrode. In one or more embodiments, the reverse is also possible, for example, the first electrode plate of the electrode assembly 110 may act as a positive electrode, and the second electrode plate may act as a negative electrode.

The negative electrode plate may be formed by applying a negative electrode active material, such as graphite and/or carbon, to a negative electrode current collector formed of a metal foil, such as copper, a copper alloy, nickel, or a nickel alloy. The negative electrode plate may include a negative electrode active material layer that is a region to which the negative electrode active material is applied. The negative electrode plate may include a negative uncoated portion that is a region to which the negative electrode active material is not applied.

The negative electrode plate may include a negative electrode tab 114 electrically connected to the negative uncoated portion. In one or more embodiments, when the negative electrode plate is manufactured, the negative electrode tab 114 may be formed by being cut in advance to protrude to one side of the electrode assembly 110, or the negative electrode tab 114 may protrude to one side of the electrode assembly 110 more than (e.g., farther than or beyond) the separator without being separately cut. The negative electrode tab 114 may include or be referred to as a first base material tab, a first electrode tab, or a first current collection tab.

The negative electrode active material, which is a first active material, may include a material capable of reversibly intercalating/deintercalating lithium ions, lithium metal, an alloy of lithium and a metal, a material capable of being doped and dedoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Non-limiting examples of the crystalline carbon may include graphite, such as natural graphite and/or artificial graphite, and non-limiting examples of the amorphous carbon may include soft carbon, hard carbon, a pitch carbide, a meso-phase pitch carbide, sintered coke, and/or the like.

A Si-based negative electrode active material or a Sn-based negative electrode active material may be used as the material capable of being doped and dedoped with lithium. The Si-based negative electrode active material may be silicon, a silicon-carbon composite, SiOₓ (0<x ≤2), a Si-based alloy, or a combination thereof.

The silicon-carbon composite may be a composite of silicon and amorphous carbon. According to one or more embodiments, the silicon-carbon composite may be in the form of a silicon particle and amorphous carbon coated on the surface of the silicon particle.

In one or more embodiments, the silicon-carbon composite may further include crystalline carbon. For example, the silicon-carbon composite may include a core including crystalline carbon and silicon particles and an amorphous carbon coating layer on the surface of the core.

A negative electrode for a lithium secondary battery may include a negative electrode current collector and a negative electrode active material layer arranged on the negative electrode current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material, based on a total weight of 100 wt % of the negative electrode active material layer.

A non-aqueous (e.g., water-insoluble) binder, an aqueous (e.g., water-soluble) binder, a dry binder, or a combination thereof may be used as the binder. If (e.g., when) an aqueous binder is used as the binder of the negative electrode, a cellulose-based compound capable of imparting viscosity may be further included.

As the negative electrode current collector, one selected from among a copper foil, a nickel foil, a stainless steel foil, a titanium foil, a nickel foam, a copper foam, a conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the lithium secondary battery can move and migrate.

The non-aqueous organic solvent may include (e.g., be) a carbonate-based solvent, an ester-based solvent, an ether-based solvent, a ketone-based solvent, an alcohol-based solvent, and/or an aprotic solvent, and may be used alone or in combination of two or more thereof.

In one or more embodiments, if (e.g., when) a carbonate-based solvent is used, a mixture of a cyclic carbonate and a chain carbonate may be used.

The positive electrode plate may be formed by applying a positive electrode active material, such as a transition metal oxide, on a positive electrode current collector formed of a metal foil, such as aluminum or an aluminum alloy. The positive electrode plate may include a positive electrode active material layer that is a region to which the positive electrode active material is applied. The positive electrode plate may include a positive uncoated portion that is a region to which the positive electrode active material is not applied.

The positive electrode plate may include a positive electrode tab 115 electrically connected to the positive uncoated portion. In one or more embodiments, when the positive electrode plate is manufactured, the positive electrode tab 115 may be formed by being cut in advance to protrude to one side of the electrode assembly 110, or the positive electrode tab 115 may protrude to one side of the electrode assembly 110 more than (e.g., farther than or beyond) the separator without being separately cut. The positive electrode tab 115 may include or be referred to as a second base material tab, a second electrode tab, or a second current collection tab.

As the positive electrode active material, which is a second active material, a compound capable of reversibly intercalating/deintercalating lithium (e.g., a lithiated intercalation compound) may be used. For example, at least one of a composite oxide of lithium and a metal selected from among cobalt, manganese, nickel, and combinations thereof may be used.

The composite oxide may be a lithium transition metal composite oxide, and non-limiting examples thereof may include a lithium nickel-based oxide, a lithium cobalt-based oxide, a lithium manganese-based oxide, a lithium iron phosphate-based compound, a cobalt-free nickel-manganese-based oxide, and/or a combination thereof.

In one or more embodiments, a compound represented by any one selected from among the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A may be nickel (Ni), cobalt (Co), manganese (Mn), or a combination thereof; X may be aluminum (Al), Ni, Co, Mn, chromium (Cr), iron (Fe), magnesium (Mg), strontium (Sr), vanadium (V), a rare earth element, or a combination thereof; D may be oxygen (O), fluorine (F), sulfur(S), phosphorus (P), or a combination thereof; G may be Al, Cr, Mn, Fe, Mg, lanthanum (La), cerium (Ce), Sr, V, or a combination thereof; and L¹ may be Mn, Al, or a combination thereof.

A positive electrode for a lithium secondary battery may include a positive electrode current collector and a positive electrode active material layer formed on the positive electrode current collector. The positive electrode active material layer may include a positive electrode active material and may further include a binder and/or a conductive material.

The content (e.g., amount) of the positive electrode active material is in a range of about 90 wt % to about 99.5 w t% on the basis of a total weight of 100 wt % of the positive electrode active material layer, and the content (e.g., amount) of the binder and the content (e.g., amount) of the conductive material are each in a range of about 0.5 w t% to about 5 wt % on the basis of the total weight of 100 wt % of the positive electrode active material layer.

The positive electrode current collector may be aluminum (Al), but embodiments of the present disclosure are not limited thereto.

In one or more embodiments, an electrode lead 130 may be provided to electrically connect the negative electrode tabs 114 and the positive electrode tab 115 to the outside. The electrode lead 130 may be connected to each of the negative electrode tab 114 and the positive electrode tab 115. In one or more embodiments, the electrode lead 130 may include a negative electrode lead and a positive electrode lead. The negative electrode tab 114 and the positive electrode tab 115 are respectively welded to a negative electrode lead and a positive electrode lead of an external terminal to be electrically connected to the outside. A tab film 135 for insulation from the pouch 120 is attached to the negative electrode lead and the positive electrode lead.

The separator may be interposed between negative and positive electrode plates to prevent or reduce electrical short circuit between the negative and positive electrode plates. In one or more embodiments, the separator is provided in a pair, and the negative electrode plate or the positive electrode plate may be sandwiched between the pair of separators.

Depending on the type (or kind) of lithium secondary battery, the separator may be present between the negative electrode and the positive electrode. As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both (e.g., simultaneously) surfaces (e.g., two opposite surfaces) of the porous substrate.

The organic material may include a polyvinylidene fluoride-based polymer and/or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof, but embodiments of the present disclosure are not limited thereto.

The organic material and the inorganic material may be mixed in one coating layer or may be in the form of a coating layer containing an organic material and a coating layer containing an inorganic material that are laminated on each other.

The pouch 120 may include or be referred to as a case, a can, an exterior, or a housing. In one or more embodiments, the pouch 120 may be provided as a laminate structure having, for example, a first insulating layer, a metal layer, and a second insulating layer. In one or more embodiments, the pouch 120 may be made of steel, stainless steel, nickel-plated steel, or a steel alloy. The pouch 120 will be described in more detail later.

In one or more embodiments, in the pouch-type (kind) secondary battery, if (e.g., when) an internal gas is accumulated, an exterior may be swelled, and thus, a sealing part may be torn to cause leakage of an electrolyte and short circuit. In the art, a metal vent cap, and/or the like, applied to prevent or reduce this phenomenon may be deteriorated in airtightness even during a normal operation, or costs and process complexity may increase due to additional components. In addition, a line or a groove that is intentionally reduced in mechanical strength for venting may be applied, and if (e.g., when) the line or the groove is ruptured later than a set pressure, thermal runaway may rapidly progress to increase in risk of fire and explosion. Due to the structural and economic limitations, it may be assessed that it is difficult to secure reliability in a high-energy density cell.

In the secondary battery 100 according to one or more embodiments of the present disclosure, an upper plate exterior may be divided into two or more layers (e.g., two or more upper plates), and then, a thermoplastic adhesive layer may be applied between the upper plates (e.g., between the two or more upper plates), and thus, if (e.g., when) an internal temperature exceeds a critical value, the adhesive layer may be selectively melted while being maintained in a completely sealed state at a normal temperature to allow an interlayer ventilation passage to be spontaneously provided.

For example, an outermost one upper plate may function as an outermost sealing layer that blocks an external impact and moisture penetration, and an inner upper plate may be integrated with the thermoplastic adhesive layer in a state, in which a cross-section in a z-axis direction (vertical direction) is opened, to perform a vent function in which a gas and an electrolyte are discharged if interlayer separation occurs under a high-temperature environment. As used herein, the term “z-axis direction” may refer to a thickness direction (vertical direction) of the secondary battery. The term “xy-axis direction” may refer to a plane (e.g., a major plane of the secondary battery) defined by an x-axis direction and a y-axis direction, and the “z-axis direction” may be normal to the plane defined by x-axis direction and the y-axis direction.

In one or more embodiments, in a structure of the secondary battery 100 according to one or more embodiments of the present disclosure, an internal pressure in a situation in which a temperature inside a cell rapidly rises is early relieved to suppress or reduce shrinkage of the separator and deformation of the electrode(s), and possibility of the thermal runaway due to thermal decomposition of the electrolyte may be significantly reduced to improve the safety of the cell. The plurality of upper plates and the thermoplastic adhesive layer may be implemented by merely adding the lamination and coating processes to an existing pouch cell manufacturing line to mass-produce high-safety and high-reliability cells while minimizing or reducing the process complexity and the increasing costs.

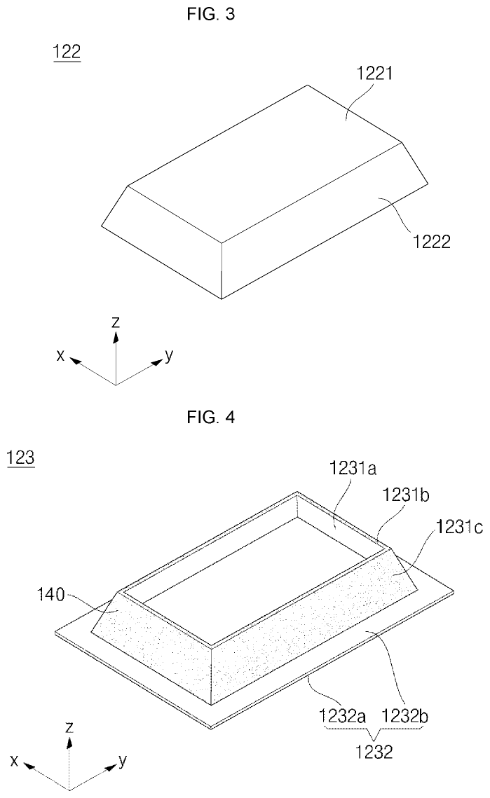

FIG. 3 illustrates a perspective view of a first upper plate 122 of the pouch 120 of the secondary battery 100 of FIG. 1 according to one or more embodiments, and FIG. 4 illustrates a perspective view of a second upper plate 123 of the pouch 120 of the secondary battery 100 of FIG. 1 according to one or more embodiments.

Referring to FIGS. 2 to 4, in one or more embodiments, the pouch 120 may include a lower plate 121, the first upper plate 122, and the second upper plate 123. The first upper plate 122 may include an upper flat part 1221 and a side connection part 1222. The second upper plate 123 may include a sidewall 1231 and a sealing part 1232.

In one or more embodiments, the pouch 120 may be provided to be constituted by the lower plate 121 having a quadrangle (e.g., square) plate shape (e.g., in a form of quadrangle plate) and the first and second upper plates 122 and 123, which are coupled to an upper portion of the lower plate 121. The pouch 120 may be sealed by allowing the second upper plate 123 and the lower plate 121 to be in contact with each other in a state in which the electrode assembly 110 is accommodated in the first upper plate 122. The first upper plate 122 and the second upper plate 123 may be laminated and bonded by a thermoplastic adhesive layer 140.

The lower plate 121 may be a bottom flat sheet that supports the electrode assembly 110 and the electrolyte. The lower plate 121 may have a plate shape (e.g., in a form of plate) corresponding to a shape of the electrode assembly 110. The lower plate 121 may be sealed by being in contact with the second upper plate 123. In one or more embodiments, the lower plate 121 may be a lower substrate of a circumferential thermal compression portion of the second upper plate 123, and if (e.g., when) the lower plate 121 and the circumferential thermal compression portions of the second upper plate 123 overlap each other to be compressed and melted to serve as a mechanical support, thereby completing a hermetic sealing layer. In one or more embodiments, the lower plate 121 may be a structural support layer that maintains its shape even if subjected to a sealing pressure and heat and may serve as a reference surface for the bonding and melting on a thermal fusion interface and concurrently (e.g., simultaneously) perform a basic blocking role of blocking the internal electrolyte and/or gas.

In one or more embodiments, the pouch 120 may be provided as a multilayer structure, in which the plurality of upper plates 122 and 123 are laminated, and may be attached using an adhesive made of a material that is melted by heat. The attached multilayer upper plate 122 and 123 may be maintained in adhesive property (e.g., in an adhered state) at an actual usage temperature to isolate the outside and inside of the cell from each other.

The first upper plate 122 may be arranged at an uppermost portion of the pouch 100 to accommodate the electrode assembly 110. The first upper plate 122 may include an upper flat part 1221 corresponding to the shape of the electrode assembly 110 and a side connection part 1222 extending at a set or predetermined angle from the upper flat part 1221 and around (e.g., surrounding) the upper flat part 1221. In one or more embodiments, a recess having a certain depth that is capable of accommodating the electrode assembly 110 may be provided in the first upper plate 122 through a press process, a drawing process, and/or the like. The recess may include or be referred to as an accommodation part.

The second upper plate 123 may be coupled to a lower portion of the first upper plate 122 and may include a portion that is thermally compressed and sealed with the lower plate 121. The second upper plate 123 may include a sidewall 1231 and a sealing part 1232 without a top surface (e.g., without a roof part) that is opened in the z-axis direction, for example, an open is defined by the sidewall 1231. The second upper plate 123 may be coupled in a form that is fitted into the inside of the first upper plate 122.

The sidewall 1231 may be coupled to be in contact with the side connection part 1222 of the first upper plate 122 and may be a wall (e.g., vertical wall) defining a space for accommodating the electrode assembly 110. In one or more embodiments, the sidewall 1231 may include an inner surface sidewall 1231a, a top surface sidewall 1231b, and an outer surface sidewall 1231c. The inner surface sidewall 1231a may be a potion at a side of the electrode assembly 110, and the outer surface sidewall 1231c may be a portion opposite to (e.g., facing) an inner surface of the side connection part 1222 of the first upper plate 122. The top surface sidewall 1231b may be a top surface connecting the inner surface sidewall 1231a to the outer surface sidewall 1231c and may be said to be the uppermost cross-section of the second upper plate 123.

The sealing part 1232 for sealing with the lower plate 121 may be provided on the second upper plate 123. The sealing part 1232 may include a bottom surface sealing part 1232a and a top surface sealing part 1232b. The bottom surface sealing part 1232a may be a surface opposite to (e.g., facing) the lower plate 121, and the top surface sealing part 1232b may be a surface facing the outside. The sealing part 1232 may be provided along all four sides on which the lower plate 121 and the second upper plate 123 are in contact with each other. In one or more embodiments, the sealing parts 1232 on two sides, excluding the side on which the negative electrode tab 114 and the positive electrode tab 115 are arranged, may include or be referred to as wing parts. In one or more embodiments, if the wing part is folded, the top surface sealing part 1232b and the outer surface sidewall 1231c of the wing part may be attached to each other.

In one or more embodiments, the sealing part 1232 corresponding to an outer circumference of the electrode assembly 110, i.e., circumferences of the second upper plate 123, and the lower plate 121 may be thermally fused with each other, and thus, the electrode assembly 110 may be accommodated inside the pouch 120 provided in an approximately pouch or pocket type (kind). For example, the electrode assembly 110 may be enclosed within the pouch 120, which is configured in a general pouch or pocket form. The sealing part 1232 may be made of a thermal fusion material and have a structure in which sealing is achieved by bonding thermal fusion layers to each other. Because the thermal fusion material generally has weak adhesion to a metal, the tab film 135 provided in the form of a thin film may be attached to the tab and then be fused with the pouch 120. In one or more embodiments, the sealing may be performed in the state in which the tab film 135 is arranged between the sealing part 1232 and the lower plate 121. As illustrated in FIG. 1 and FIG. 2, a form in which the tab film 135 is attached to each of the negative electrode tab 114 and the positive electrode tab 115 may be defined as a ‘separable tab film’ (this sealing structure is defined as a separable sealing structure). However, the separable sealing structure may have limitations with reduced workability and productivity because the separable sealing structure requires a structure in which the tab film 135 is attached to each tab and is welded to the tab and then is thermally fused again with the pouch 120.

In one or more embodiments, the upper plates 122 and 123 of the pouch 120 may be manufactured in multiple layers and attached to each other using a thermoplastic adhesive made of a material that is melted at a high temperature, which is provided between the upper plates 122 and 123, to cause early venting during heating evaluation and suppressing ignition by discharging the electrolyte and the gas. Thus, the internal pressure that may deform the electrode assembly 110 may be relieved, and the electrolyte that causes acceleration of the shrinkage of the separator may be removed. In one or more embodiments, the short circuit and the thermal runaway caused by damage of the electrode assembly 110 may be suppressed.

In one or more embodiments, the first upper plate 122 and the second upper plate 123 may be attached by the thermoplastic adhesive layer 140, and thus, the inside and outside of the cell may be isolated from each other while maintaining the adhesive property at the actual usage temperature, and in a situation in which the temperature abnormally increases (for example, approximately (about) 120 degrees (°C) or more), the thermoplastic adhesive layer 140 may be melted to function as a vent.

In one or more embodiments, the thermoplastic adhesive layer 140 may be arranged on the top surface sidewall 1231b and the outer surface sidewall 1231c of the second upper plate 123 to couple the first upper plate 122 to the second upper plate 123.

The thermoplastic adhesive layer 140 may be provided in an area coating manner on at least a portion or an entire surface of an area of the top surface sidewall 1231b corresponding to an uppermost surface of the second upper plate 123 in the z-axis direction and the outer surface sidewall 1231c corresponding to an outer side surface of the second upper plate 123 in an xy-axis direction. The outer surface sidewall 1231c may serve as a main bonding interface, on which the first upper plate 122 and the second upper plate 123 are coupled to each other, to absorb a thermal expansion difference, and the top surface sidewall 1231b may be continuously covered along a cut cross-section of the second upper plate 123 to seal a metal exposure portion. If (e.g., when) the multilayer upper plate is laminated and thermally compressed, the thermoplastic adhesive layer 140 may have excellent or suitable flowability and wettability to be filled into a micro-pore, thereby concurrently (e.g., simultaneously) ensuring the airtightness of the bonded and coupled portion and the pressure resistance between the layers.

In one or more embodiments, the thermoplastic adhesive layer 140 may be applied by spraying a thin film through an airless spray nozzle so that the adhesive is not spread in a direction of gravity to provide a substantially uniform covering layer. In one or more embodiments, a dipping process in which the second upper plate 123 is inserted into a melted adhesive tank and then withdrawn at a constant speed may be utilized. In one or more embodiments, a pre-cast hot melt film may be die-cut using a roll-to-roll lamination method and then attached using a heat-compression roll. In one or more embodiments, the melted adhesive may be applied without interruption by continuously discharging the melted adhesive by quantitatively pumping the melted adhesive through a slot die head.

In one or more embodiments, because the application area is narrow on the top surface sidewall 1231b, a method such as precision application, direct application, or dipping the surface into the melted adhesive may be applied if (e.g., when) applying the thermoplastic adhesive layer 140. If (e.g., when) the application area is narrow, the adhesive may be spread unnecessarily, or it may be difficult to secure a substantially uniform thickness. Thus, a discharge amount and position may be controlled or selected in micrometer units by using a precision dispenser having a micro channel to uniformly (e.g., substantially uniformly) laminate the adhesive only on a target area. In one or more embodiments, to simplify the application process, the adhesive may be applied in a direct contact manner using tools such as a spatula, a fine roller, or a micro brush. In one or more embodiments, if (e.g., when) the application area is narrow, and it is difficult to secure productivity even with the precision discharging or the direct contact, the dipping process in which a target surface is momentarily immersed in a melted adhesive pool and then removed may be applied. After the dipping, a natural flow may be induced in a still air state to ensure film flatness, and pre-curing may be performed in an oven to fix the adhesive so that the adhesive does not flow.

The thermoplastic adhesive layer 140 may have a structural role for the coupling between the first upper plate 122 and the second upper plate 123 as well as a functional role for insulating the cross-section of the pouch. In one or more embodiments, the thermoplastic adhesive layer 140 may significantly increase in corrosion resistance and electrochemical stability by completely covering the metal layer on the cross-section of the second upper plate 123 to provide an insulating barrier, thereby preventing the direct contact with the electrolyte. In one or more embodiments, the thermoplastic adhesive layer 140 applied to the top surface sidewall area 1231b may prevent or reduce lithium ions of an electrode active material from causing a corrosion reaction by moving to an aluminum metal layer through the electrolyte, thereby suppressing or reducing deterioration of the pouch 120 and changing/improving electrochemical performance. In addition, the thermoplastic adhesive layer 140 may improve the safety by delaying local rupture of the sealing part 1232 if (e.g., when) the pressure inside the pouch cell increases or by inducing rupture between the upper flat part 1221 and the sidewall 1231.

In one or more embodiments, the thermoplastic adhesive layer 140 may be composed of α-methylstyrene-acrylonitrile copolymer (AMSAN), linear low density polyethylene (LLDPE), high density polyethylene (HDPE), and/or the like, as main components and have a melting point of approximately (about) 110 degrees (°C) to approximately (about) 132 degrees (°C), so that a polymer network is firmly maintained at a normal operation temperature and rapidly fluidizes under an abnormal high temperature environment to cause formation of an interlayer ventilation passage. As used herein, the term “normal operation temperature” may refer a temperature under which a secondary battery may output desired and/or suitable electrical power, for example, may be in a range from about −20 °C to about 80 °C, about −20 °C to about 60 °C, about 0 °C to about 60 °C, or about 0 °C to about 45 °C. The AMSAN may be an amorphous copolymer of α-methylstyrene and acrylonitrile. If (e.g., when) heated, the AMSAN may flow smoothly at a temperature of approximately (about) 120 degrees (°C) and thus be used as an interlayer adhesive layer, and after cooled, the AMSAN may maintain excellent or suitable heat resistance and transparency to function as an insulating layer on the cross-section of the pouch. The LLDPE may be linear low-density polyethylene manufactured by a low-pressure copolymerization process and may have excellent or suitable tensile strength and fatigue resistance due to its short side chain structure and exhibit a viscoelastic flow at a temperature of approximately (about) 110 degrees (°C) to approximately (about) 125 degrees (°C) and thus may be used as a thermal fusion adhesive. The HDPE may be high-density polyethylene with high crystallinity, which is melted at a temperature of approximately (about) 125 degrees (°C) to approximately (about) 132 degrees (°C) and has high mechanical strength, and also may have excellent or suitable chemical resistance to acids/alkali and the electrolyte to protect the exterior even after the adhesive layer is ruptured.

In one or more embodiments, the thermoplastic adhesive layer 140 may contain a small amount of high-crystallinity polyolefin-based reinforcing agent to suppress or reduce delamination or cracking even under an impact and vibration, thereby concurrently (e.g., simultaneously) improving the bonding strength and fracture pressure uniformity. In one or more embodiments, the thermoplastic adhesive layer 140 may be re-solidified to restore its airtightness after cooled even if heated at the high temperature, thereby minimizing or reducing external moisture inflow even after single venting.

Ethylene vinyl acetate (EVA), an ethylene acrylic acid copolymer (EAA), an ethylene methacrylic acid copolymer (EMAA), an ionized ethylene copolymer (Ionomer), ethylene butylacrylate (EBA), thermoplastic polyurethane (TPU), polyvinylidene fluoride (PVDF), glycol-modified polyethylene terephthalate (PET) (PETG), a cycloolefin resin (e.g., cyclic olefin polymer (COP), cyclic olefin copolymer (COC)), a styrene ethylene butylene styrene (SEBS) block copolymer, and/or the like, may be applied as the thermoplastic adhesive layer 140. These materials have one or more suitable melting points, glass transition points, and polarities to provide good or suitable chemical adhesion to the metal layer on the cross-section of the upper plate and ensure fluidity at the high temperature, thereby providing the vent passage.

In terms of the manufacturing process, the thermoplastic adhesive layer 140 may be a thermoplastic material that does not require separate curing after the lamination process and thus may be easily applied to the existing pouch cell line by simply adding the lamination, compression, and cooling processes. The thermoplastic adhesive layer 140 may be applied in a stripe shape (e.g., in a shape of stripe) along an edge of a film using a continuous roll-to-roll process, and coating quality may be monitored in on-line using a resin containing a UV tracer, if necessary. In addition, the thermoplastic adhesive layer 140 partially remains even after releasing the thermal fusion to maintain a gap between the layers, thereby preventing rapid re-bonding after the gas venting is completed and maintaining a residual pressure relief function. As a result, the thermoplastic adhesive layer 140 may contribute economically to the mass production of the cell having high-energy density if (e.g., when) considering process efficiency and material costs.

In one or more embodiments, a third upper plate 124 may be additionally interposed between the first upper plate 122 and the second upper plate 123. In addition, although only the third upper plate 124 is described in this disclosure, a plurality of upper plates may be additionally interposed.

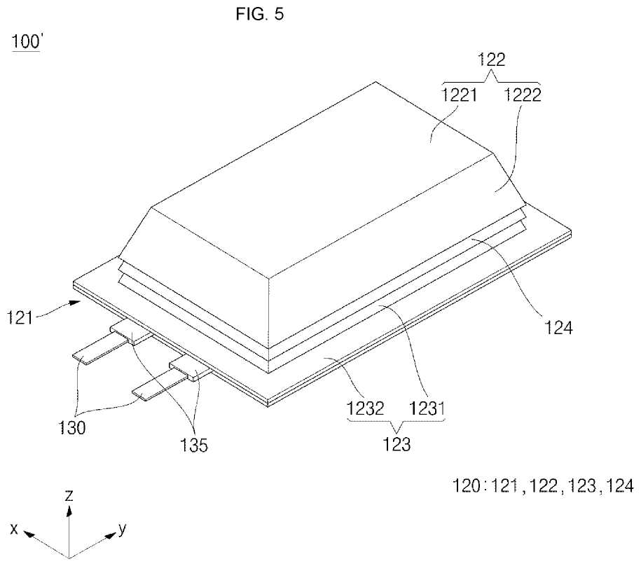

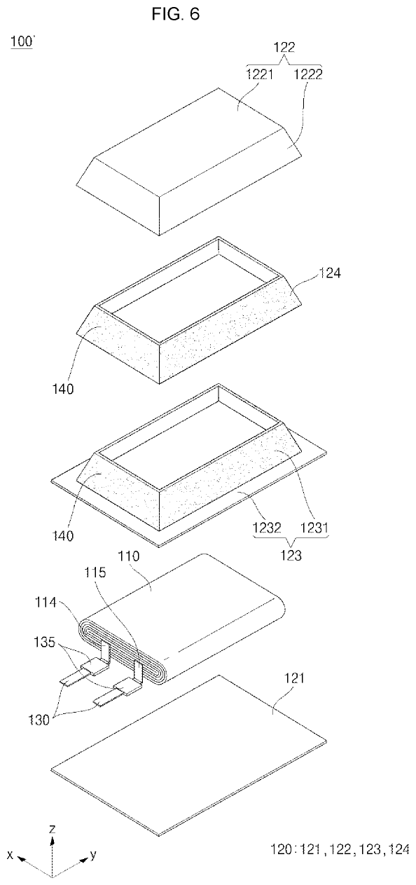

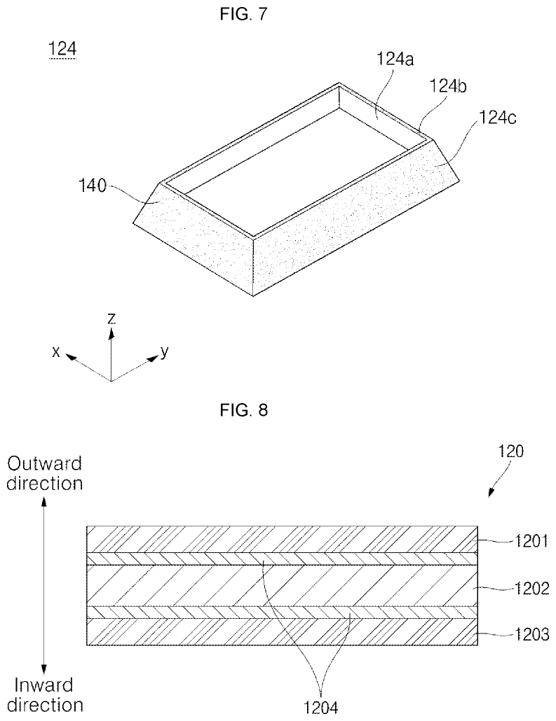

FIG. 5 is a perspective view of a structure of a secondary battery 100′ according to one or more embodiments of the present disclosure, FIG. 6 illustrates an exploded perspective view of the secondary battery 100′ of FIG. 5 according to one or more embodiments, and FIG. 7 illustrates a perspective view of a third upper plate 124 of a pouch 120 of the secondary battery 100′ of FIG. 5 according to one or more embodiments.

Referring to FIGS. 5 to 7, the pouch 120 of the secondary battery 100′ may include a lower plate 121, a first upper plate 122, a second upper plate 123, and a third upper plate 124. In one or more embodiments, the pouch 120 may be provided to be constituted by the lower plate 121 having a quadrangle (e.g., rectangle or square) plate shape (e.g., in a form of quadrangle plate) and the first, second, and third upper plates 122, 123, and 124, which are coupled to an upper portion of the lower plate 121. The pouch 120 may be sealed by allowing the second upper plate 123 and the lower plate 121 to be in contact with each other in a state in which the electrode assembly 110 is accommodated in the first upper plate 122. The first upper plate 122, the second upper plate 123, and the third upper plate 124 may be laminated and bonded by the thermoplastic adhesive layer 140. Because the lower plate 121, the first upper plate 122, and the second upper plate 123 may be implemented identically and/or similarly to the secondary battery 100 described above, the third upper plate 124 will be chiefly described.

The third upper plate 124 may be interposed between the first upper plate 122 and the second upper plate 123 and may be coupled in a form that is inserted into the first upper plate 122. In addition, the second upper plate 123 may be coupled in a form that is inserted into the third upper plate 124.

In one or more embodiments, the pouch 120 may be provided to be constituted by the lower plate 121 having a quadrangle (e.g., rectangle or square) plate shape (e.g., in a form of quadrangle plate) and the first, second, and third upper plates 122, 123, and 124, which are coupled to an upper portion of the lower plate 121. The pouch 120 may be sealed by allowing the second upper plate 123 and the lower plate 121 to be in contact with each other in a state in which the electrode assembly 110 is accommodated in the first upper plate 122. The first upper plate 122, the second upper plate 123, and the third upper plate 124 may be laminated and bonded by the thermoplastic adhesive layer 140.

The third upper plate 124 may be coupled to a lower portion of the first upper plate 122 and an upper portion of the second upper plate 123 and may be provided as a sidewall without a top surface (e.g., without a top wall) by being opened in the z-axis direction, for example, an open is defined by the sidewall. In one or more embodiments, the third upper plate 124 may be in the form of a frame constituted by an inner surface 124a, an outer surface 124c, and a top surface 124b connecting the inner surface 124a to the outer surface 124c.

The outer surface 124c of the third upper plate 124 may be coupled by being in contact with a side connection part 1222 of the first upper plate 122, and the inner surface 124a may be coupled by being in contact with an outer surface sidewall 1231c of the second upper plate 123. In one or more embodiments, the inner surface 124a may be a portion at a side of the electrode assembly 110 or a side of the second upper plate 123, and the outer surface 124c may be a portion opposite to (e.g., facing) the inner surface of the side connection part 1222 of the first upper plate 122. The top surface 124b may be a top surface connecting the inner surface 124a to the outer surface 124c and may be said to be an uppermost cross-section of the third upper plate 124.

As described above, in one or more embodiments, the upper plates 122, 123, and 124 of the pouch 120 may be manufactured in multiple layers and attached to each other using a thermoplastic adhesive made of a material that is melted at a high temperature, which is provided between neighboring upper plates 122, 123, and 124, to cause early venting during heating evaluation and suppressing ignition by discharging the electrolyte and the gas. Thus, the internal pressure that may deform the electrode assembly 110 may be relieved, and the electrolyte that causes acceleration of the shrinkage of the separator may be removed.

In one or more embodiments, the first upper plate 122 and the third upper plate 124, and the third upper plate 124 and the second upper plate 123 may each be attached by the thermoplastic adhesive layer 140, and thus, the inside and outside of the cell may be isolated from each other while maintaining the adhesive property at the actual usage temperature, and in a situation in which the temperature abnormally increases (for example, approximately (about) 120 degrees (°C) or more), the thermoplastic adhesive layer 140 may be melted to function as a vent.

In one or more embodiments, the thermoplastic adhesive layer 140 may be arranged on the top surface 124b and the outer surface 124c of the third upper plate 124 to couple the first upper plate 122 to the third upper plate 124. In addition, the thermoplastic adhesive layer 140 may be arranged on the top surface sidewall 1231b and the outer sidewall 1231c of the second upper plate 123 to couple the third upper plate 124 to the second upper plate 123.

The thermoplastic adhesive layer 140 may be provided in an area coating manner on at least a portion or an entire surface of an area of the top surface 124b corresponding to an uppermost surface of the third upper plate 124 in the z-axis direction and the outer surface 124c corresponding to an outer side surface of the third upper plate 124 in an xy-axis direction. In addition, the thermoplastic adhesive layer 140 may be provided in an area coating manner on at least a portion or an entire surface of an area of the top surface sidewall 1231b corresponding to the uppermost surface of the second upper plate 123 in the z-axis direction and the outer surface sidewall 1231c corresponding to an outer side surface of the second upper plate 123 in an xy-axis direction. The outer surface 124c and the outer surface sidewall 1231c may serve as a main bonding interfaces that couples the first upper plate 122 to the third upper plate 124 and couples the third upper plate 124 to the second upper plate 123 to absorb a thermal expansion difference. In addition, the top surface 124b and the top surface sidewall 1231b may be continuously covered along a cut cross-section of the third upper plate 124 and the second upper plate 123 to seal a metal exposure portion.

FIG. 8 is a cross-sectional view of a cut surface of each upper plate of the pouch 120 according to one or more embodiments of the present disclosure.

Referring to FIG. 8 in conjunction with FIG. 1-7, each layer of the upper plate may be manufactured as a multi-layer exterior that is called a pouch. In one or more embodiments, in the lowermost surface of the side connection part 1222 of the first upper plate 122, the top surface sidewall 1231b of the second upper plate 123, and the top surface 124b of the third upper plate 124, multi-layers may be exposed and covered by the thermoplastic adhesive layer 140. In addition, the lower plate 121 according to one or more embodiments may also be manufactured using a same multi-layer exterior as each of the upper plates 122, 123, and 124.

In one or more embodiments, each of the upper plates 122, 123, and 124 may be provided in a multilayer structure including an outer layer 1201, a central layer 1202, an inner layer 1203, and an adhesive layer 1204 that couples the above-described layers to each other. The layers may be made of materials having different properties to serve to protect the inside of the cell and improve mechanical and chemical reliability of the battery.

The outer layer 1201 may be mainly provided as an aromatic polyamide polymer film such as a nylon series. Because the outer layer is the outermost layer of the exterior and is directly exposed to an external environment to protect the internal components from physical damage such as scratches, impacts, and perforations. In addition, a nylon film may have excellent or suitable mechanical strength and flexibility at the same time to prevent or reduce damage and deformation caused by an external pressure and vibration. In addition, it may have excellent or suitable insulating properties and chemical resistance to effectively block penetration of external moisture, oxygen, and other contaminants, thereby maintaining chemical stability of the internal electrode and the electrolyte for a long period of time.

The central layer 1202 may be made of aluminum (Al) foil or other similar metal material foil. The central layer 1202 may ensure airtightness of the entire exterior and almost completely block the penetration of the gas and moisture to prevent or reduce degradation of the battery performance due to evaporation of the electrolyte inside the battery or penetration of the external moisture. In addition, the central layer 1202 may have mechanical rigidity and high thermal conductivity to effectively release heat generated inside the cell to the outside, thereby improving thermal stability of the battery. This may minimize or reduce internal heat accumulation and suppress or reduce structural deformation of the cell even under abnormal situations such as the charging/discharging and/or the thermal runaway.

The inner layer 1203 may be provided as a thermoplastic film based on polypropylene (PP), and the inner layer 1203 may be arranged on the innermost surface of the pouch exterior and thus may be in direct contact with the electrolyte and the electrode assembly 110 inside the battery. The inner layer may have the property of easily melting, especially at a low temperature (around about 130 °C) to secure the airtightness at the bonded portion between the upper and lower plates through the heat fusion. In addition, polypropylene used as the inner layer 1203 may have excellent or suitable chemical resistance and electrochemical stability to prevent or reduce chemical corrosion and deterioration even after in long-term contact with the electrolyte, thereby maintaining the stability of the electrochemical reaction inside the cell.

The adhesive layer 1204 may be an interfacial adhesive layer that performs an interlayer adhesive function to firmly bond the outer layer 1201, the central layer 1202, and the inner layer 1203 and may mainly include a thermosetting or special thermoplastic resin having excellent or suitable interfacial adhesiveness and chemical resistance. For example, materials such as polyurethane (PU)-based adhesives, modified polyolefin adhesives, epoxy resin-based adhesives, acrylic adhesives, or polyester resin adhesives may be used.

In one or more embodiments, the polyurethane adhesive may have excellent or suitable flexibility and interfacial adhesion and may effectively maintain bonding between the outer layer 1201 and the central layer 1202 and/or between the central layer 1202 and the inner layer 1203. In addition, the epoxy-based adhesive may provide strong mechanical strength and chemical resistance and may secure excellent or suitable bonding strength at an interface between the metal layer and the polymer layer, thereby improving the structural stability. The acrylic adhesive may have high transparency and excellent or suitable weather resistance to maintain interlayer bonding stability over the long term. In one or more embodiments, the modified polyolefin adhesive may improve chemical affinity with the inner layer such as polypropylene and improve bonding strength between the thermoplastic resin and the metal layer. In addition, the polyester resin-based adhesive may have excellent or suitable heat resistance and electrical insulation properties to stably perform an adhesive function even in various operation environments.

The adhesive layer 1204 may integrate each constituting layer of the upper plate to suppress or reduce the deformation due to the mechanical stress and temperature changes and maintain the structural stability and reliability of the entire cell for a long period of time.

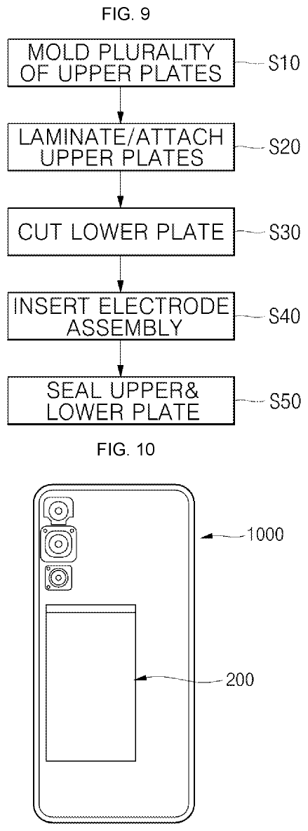

FIG. 9 is a flowchart for explaining a method for manufacturing secondary batteries 100 and 100′ according to one or more embodiments of the present disclosure.

Referring to FIGS. 1 to 9, in a method for manufacturing the secondary batteries 100 and 100′ according to one or more embodiments, first, an exterior of each upper plate is molded using a multilayer film material (S10). In operation S10, a multilayer exterior including a nylon-based outer layer 1201, a central layer 1202 made of metal foil (e.g., aluminum metal), a polypropylene-based inner layer 1203, and an adhesive layer 1204 for strong adhesion between the layers may be prepared. In one or more embodiments, the upper plates 122, 123, and 124 may be provided in a form in which a plurality of upper plates are laminated, for example, the first upper plate 122 may be processed into a form including a recess having a certain depth through press or drawing processing. In addition, a sealing part 1232 for sealing with the lower plate 121 may be formed on the second upper plate 123. In addition, the third upper plate 124 interposed between the first upper plate 122 and the second upper plate 123 may be formed in a frame shape (e.g., in a shape of a frame) having sidewalls penetrated (e.g., extended) in a vertical direction. One or more third upper plates 124 may be provided.

Next, a thermoplastic adhesive layer 140 may be applied to surfaces of the second upper plate 123 and the third upper plate 124 on the manufactured exterior of the upper plates, and then, the first upper plate 122, the second upper plate 123, and the third upper plate 124 may be laminated and attached (S20). The thermoplastic adhesive layer 140 may be made of a material such as AMSAN, LLDPE, or HDPE and may be precisely applied to the selected surface of the upper plate at a substantially uniform thickness by one or more of a spraying method, a slot die method, or a dipping method. In this process, the upper plate exterior may be laminated to form perfect seal between the inside and outside at a normal operation temperature, but in a high-temperature situation in which an internal temperature exceeds a critical value, selective melting may occur between the layers (e.g., between the upper plates) to allow spontaneous formation of a vent passage.

Next, to manufacture the lower plate 121 of the exterior, the multilayer film may be precisely cut into a desired or required size and shape (S30). The lower plate 121 may be manufactured with a same multi-layer structure as the upper plates 122, 123, and 124 and may be prepared by being cut to an optimal or suitable thickness and shape while considering mechanical strength, chemical resistance, and heat-sealing performance.

An electrode assembly 110 and an electrolyte may be inserted between the prepared lower plate 121 and the multilayer-laminated upper plates 122, 123, and 124 (S40). The electrode assembly 110 may be configured in a form including a positive electrode, a negative electrode, and a separator, which are arranged at accurate positions within an accommodation space. Then, a necessary amount of the electrolyte may be injected to promote activation and electrochemical reaction within the electrode assembly 110.

Finally, after the upper plates 122, 123, and 124 and the lower plate 121 are in contact with each other, a circumferential area on which the electrode assembly 110 is not pressed may be sealed by heat fusion (S50). In this process, a polypropylene-based inner layer 1203 may be melted at a relatively low temperature (about 130 degrees (°C)) to firmly seal a bonding part between the upper and lower plates. In one or more embodiments, an area on which an electrode tab is arranged during thermal fusion may improve adhesion to a metal layer by utilizing a tab film and/or the like to achieve perfect sealing performance.

FIG. 10 is a view schematically showing a smartphone 1000 equipped with a secondary battery 200 according to one or more embodiments of the present disclosure. As shown in FIG. 10, the secondary battery 200 according to one or more embodiments may be a small battery mounted in a small portable device such as a smartphone 1000. The secondary battery 200 may be substantially identical or similar to the above-described secondary battery 100. In this regard, because the secondary battery 200 is configured to be able to increase the capacity thereof while having a slim internal structure, the secondary battery 200 may be a battery suitable for application to small portable devices. As used herein, the terms “secondary battery pack” and “battery” have the same meaning and are different only in expression for convenience of description.

In addition, the secondary battery 200 according to one or more embodiments may include (e.g., consist of) a single cell, but may be used to manufacture a battery pack including a plurality of cells or to manufacture a larger battery pack by increasing the sizes of the battery cells.

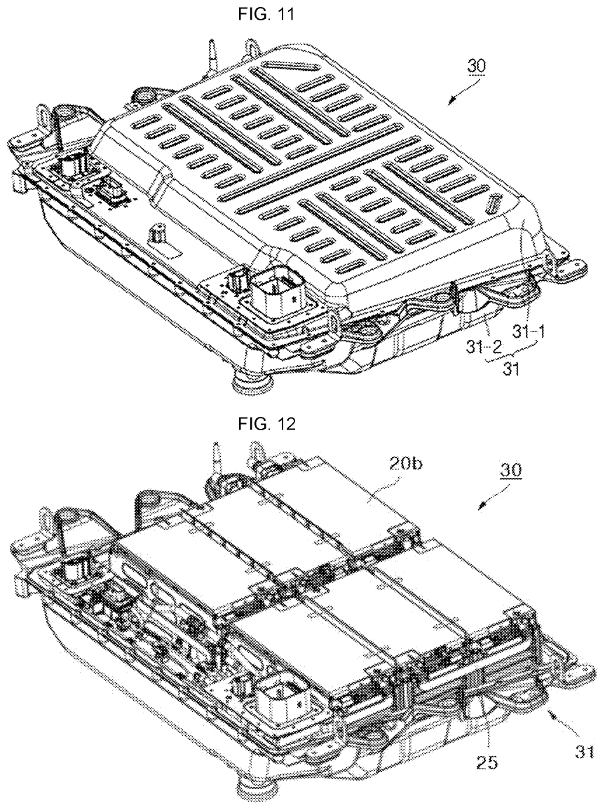

FIGS. 11 and 12 are perspective views showing an example battery pack 30 according to one or more embodiments. The battery pack 30 may include a plurality of battery modules 20b and a housing 31 for accommodating the plurality of battery modules 20b. For example, the housing 31 may include first and second housings 31-1 and 31-2 coupled in opposite directions to accommodate the plurality of battery modules 20b. The plurality of battery modules 20b may be electrically connected to each other by using a bus bar 25, and the plurality of battery modules 20b may be electrically connected to each other in a series/parallel or series-parallel mixed method, thereby obtaining desired or required electrical output.

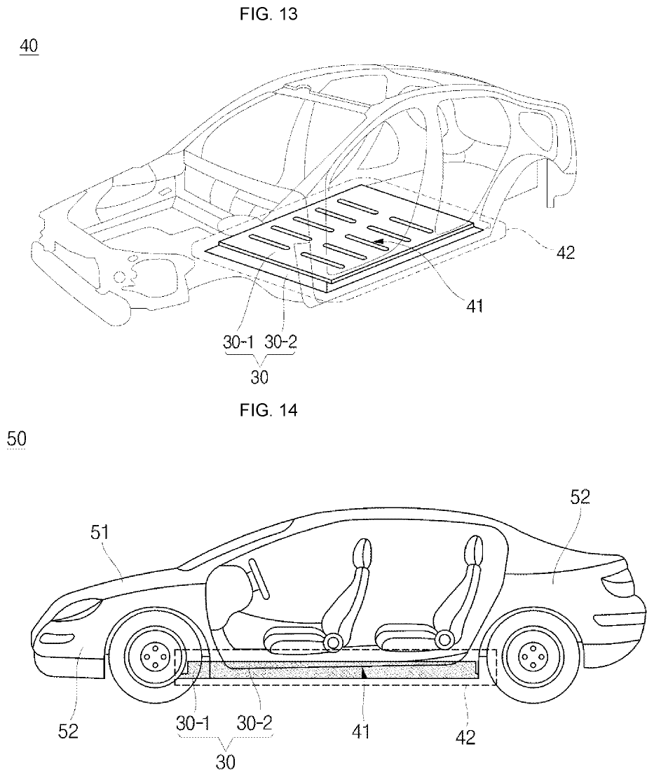

FIGS. 13 and 14 illustrate perspective and side views of examples of a vehicle body 40 and vehicle components according to one or more embodiments. In FIG. 13, a battery pack 30 may include a battery pack cover 30-1, which is a part of a vehicle underbody 41, and a pack frame 30-2 located under the vehicle underbody 41. In one or more embodiments, the battery pack cover 30-1 may correspond to the first housing 31-1, and the pack frame 30-2 may correspond to the second housing 31-2. The pack frame 30-2 and the battery pack cover 30-1 may be integrally formed with a vehicle floor 42. The vehicle underbody 41 separates the inside and outside of a vehicle, and the pack frame 30-2 may be located outside the vehicle.

Referring to FIG. 14 in conjunction with FIG. 13, a vehicle 50 may be formed by combining additional parts, such as a hood 51 in the front of the vehicle and fenders 52 respectively located in the front and rear of the vehicle to a vehicle body 40. The vehicle 50 may include the battery pack 30 that includes the battery pack cover 30-1 and the pack frame 30-2, and the battery pack 30 may be coupled to the vehicle body 40.

According to one or more embodiments of the present disclosure, the structure of the exterior of the battery that automatically provides the ventilation passage if the internal temperature rises through the exterior lamination design and the applying of the thermoplastic adhesive layer to quickly and stably discharge the gas and maintains the completely sealed state during normal times may be provided to secure the stability of the battery without the complex process. For example, a secondary battery may be provided with an exterior structure that automatically forms a ventilation passage when the internal temperature rises, thereby enhancing safety and reliability. This functionality is achieved through a laminated exterior design in which at least two upper plates are joined via a thermoplastic adhesive layer. Under normal operating conditions, the adhesive layer maintains a sealed state, ensuring containment of the electrode assembly and preventing gas leakage. However, when the internal temperature exceeds a predetermined critical threshold—within a range of about 110 °C to about 132 °C—the thermoplastic adhesive layer melts, creating a vent passage between the upper plates to allow rapid and stable discharge of gas. This passive venting mechanism eliminates the need for additional mechanical components or complex venting systems, thereby simplifying the battery structure and manufacturing process. The method of manufacturing ensures precise alignment and thermal bonding of the plates while integrating the adhesive layer in a manner that supports both sealing and venting functions. The described structure and process as illustrated above demonstrate how the combination of material properties and layered configuration contributes to improved thermal responsiveness, manufacturability, and operational safety of the secondary battery.

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, ±20%, ±10%, or ±5% of the stated value. Also, it should be understood that, even if the terms “about,” “approximately,” or “substantially” are not expressly recited in a given element (e.g., a claim element), the scope of such element is intended to include variations that are insubstantial or within the understanding of one of ordinary skill in the art. For example, numerical values and ranges provided herein are intended to include tolerances and measurement uncertainties that would be recognized by those skilled in the art, and the elements (e.g., claim elements) should be construed accordingly to encompass such equivalents.

In the context of the present disclosure and unless otherwise defined, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery manufacturing device, a battery pack, a battery management system (BMS) device, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In addition, the aspects and features of the present disclosure are not limited to those described above, and other aspects and features not expressly described herein will be clearly understood by a person skilled in the art from the description of example embodiments of the present disclosure described herein.

Although the present disclosure has been described with reference to one or more embodiments and drawings illustrating aspects thereof, the present disclosure is not limited thereto. Various modifications and variations may be made by a person skilled in the art to which the present disclosure belongs. In other words, the scope of the present disclosure is defined by the appended claims and equivalents thereof rather than the detailed description described above, and all modifications and alterations derived from the claims and their equivalents fall within the scope of the present disclosure.

What is claimed is:

1. A secondary battery, comprising:
an electrode assembly;
a case comprising a lower plate and an upper plate, the case being configured to accommodate the electrode assembly and sealed by thermally compressing the lower plate and the upper plate along a circumferential direction, the upper plate comprising at least two upper plates; and
a thermoplastic adhesive layer interposed between the at least two upper plates,
wherein the thermoplastic adhesive layer is maintained in adhesion at a normal operation temperature, and when an internal temperature of the secondary battery exceeds a set critical temperature, the thermoplastic adhesive layer is melted to provide a vent passage between the at least two upper plates.

2. The secondary battery as claimed in claim 1, wherein the at least two upper plates comprise:
a first upper plate comprising an upper flat part corresponding to a shape of the electrode assembly and a side connection part bent at a set angle from the upper flat part toward the lower plate to extend; and
a second upper plate comprising a sealing part that is thermally fused with the lower plate and a sidewall bent at a set angle from the sealing part toward the first upper plate to extend.

3. The secondary battery as claimed in claim 2, wherein the second upper plate is coupled to be fitted into the first upper plate.

4. The secondary battery as claimed in claim 2, wherein the sidewall comprises:
an inner surface sidewall at a side of the electrode assembly;
an outer surface sidewall at a side of the side connection part of the first upper plate; and
a top surface sidewall between the inner surface sidewall and the outer surface sidewall.

5. The secondary battery as claimed in claim 4, wherein the thermoplastic adhesive layer is on the outer surface sidewall and the top surface sidewall of the second upper plate.

6. The secondary battery as claimed in claim 2, wherein the sealing part is only on a circumferential area in which the electrode assembly is not arranged.

7. The secondary battery as claimed in claim 2, wherein the at least two upper plates further comprise a third upper plate interposed between the first upper plate and the second upper plate and provided in a shape of a frame.

8. The secondary battery as claimed in claim 7, wherein the third upper plate is coupled to be fitted into the first upper plate, and
the second upper plate is coupled to be fitted into the third upper plate.

9. The secondary battery as claimed in claim 7, wherein the third upper plate comprises;
an inner surface at a side of the second upper plate;
an outer surface at a side of the first upper plate; and
a top surface between the inner surface and the outer surface, and
wherein the thermoplastic adhesive layer is on the second upper plate and the top surface and the outer surface of the third upper plate.

10. The secondary battery as claimed in claim 1, wherein the thermoplastic adhesive layer has a melting point in a range from 110 degrees (°C) to 132 degrees (°C).

11. The secondary battery as claimed in claim 1, wherein the thermoplastic adhesive layer is made of at least one of a polyolefin resin or a styrene resin.

12. The secondary battery as claimed in claim 1, wherein the thermoplastic adhesive layer comprises at least one of α-methylstyrene acrylonitrile copolymer, linear low density polyethylene, or high density polyethylene.

13. The secondary battery as claimed in claim 1, wherein the thermoplastic adhesive layer is on an outer surface of an inner upper plate of the at least two upper plates and is on an entire or at least a portion of the outer surface of the inner upper plate.

14. The secondary battery as claimed in claim 1, wherein each upper plate of the at least two upper plates has a multi-layer structure comprising:
an outer layer;
a central layer;
an inner layer; and
an adhesive layer configured to couple the outer layer, the central layer, and the inner layer to one another.

15. The secondary battery as claimed in claim 14, wherein the outer layer is made of a nylon-based film, the central layer is made of a metal film, and the inner layer is made of a polypropylene film or a polyolefin-based film.

16. The secondary battery as claimed in claim 14, wherein the adhesive layer comprises at least one resin of polyurethane, modified polyolefin, epoxy, acrylic, or polyester.

17. A method, comprising:
preparing a first upper plate comprising an accommodation part configured to accommodate an electrode assembly and a second upper plate comprising a sealing part configured to be thermally fused with a lower plate;
interposing a thermoplastic adhesive layer between the first upper plate and the second upper plate to couple the first upper plate to the second upper plate;
preparing the lower plate with a shape and a size corresponding to those of the second upper plate so as to be thermally fused with the sealing part of the second upper plate;
arranging the electrode assembly in the accommodation part of the first upper plate; and
thermally fusing the lower plate and the sealing part of the second upper plate to seal the first upper plate and the second upper plate,
wherein the thermoplastic adhesive layer is maintained in adhesiveness at a normal operation temperature, and when an internal temperature exceeds a set critical temperature, the thermoplastic adhesive layer is melted to form a vent passage between the first upper plate and the second upper plate, and
wherein the method is a method for manufacturing a secondary battery.

18. The method as claimed in claim 17, wherein the thermoplastic adhesive layer is applied utilizing at least one of a spraying method, a slot die method, or a dipping method.

19. The method as claimed in claim 17, wherein the thermoplastic adhesive layer is applied by being melted in a temperature range of 110 degrees (°C) to 132 degrees (°C).

20. The method as claimed in claim 17, wherein the interposing of the thermoplastic adhesive layer between the first upper plate and the second upper plate to couple the first upper plate to the second upper plate comprises:
preparing a third upper plate in a shape of a frame that is extended in a vertical direction;
interposing the thermoplastic adhesive layer between the first upper plate and the third upper plate and between the third upper plate and the second upper plate; and
coupling the third upper plate between the first upper plate and the second upper plate.
